(19) United States
(12) Patent Application Publication
(10) Pub. No.: US 2016/0000289 A1
(43) Pub. Date: Jan. 7, 2016

(54) SELF-PROPELLED VACUUM CLEANER

(71) Applicant: SHARP KABUSHIKI KAISHA, Osaka-shi, Osaka (JP)

(72) Inventors: Toshihiro SENOO, Osaka-shi (JP); Junichi NOIRI, Osaka-shi (JP)

(21) Appl. No.: 14/766,998

(22) PCT Filed: Feb. 14, 2014
(86) PCT No.: PCT/JP2014/053490

§ 371 Date: Aug. 11, 2015

(30) Foreign Application Priority Data
Apr. 4, 2013 (JP) 2013-078845

(51) Int. Cl. A47L 9/28

(52) U.S. Cl. CPC A47L 9/2852; A47L 9/2805; A47L 2201/04

(57) ABSTRACT

A self-propelled vacuum cleaner comprising a housing; traveling members for allowing the housing to travel; cleaning members for cleaning a floor surface; an obstacle detection unit for detecting positions of obstacles present around the housing; and a control unit for controlling the traveling members, the cleaning members and the obstacle detection unit to allow the housing to clean the floor surface while the housing is self-propelled, wherein the control unit controls the obstacle detection unit to detect the positions of the obstacles around the housing and determines a traveling time to clean the floor surface on the basis of the positions of the obstacles.

### TECHNICAL FIELD

This invention relates to a self-propelled vacuum cleaner provided with self-propelled means.

### BACKGROUND ART

In recent years self-propelled vacuum cleaners that are self-propelled while avoiding obstacles autonomously have been known. Patent Document 1, for example, discloses a self-traveling cleaner provided at its main unit with an obstacle avoiding control mode that changes a movement direction of the main unit when obstacle detecting means detects an obstacle during movement of the main unit.

In such self-traveling cleaners, it is desired that their operating hours are configured depending on a size of a room or a work area. Patent Document 2, for example, discloses a mobile work robot provided with a battery voltage detection means and a travel distance measuring means, wherein the battery voltage detection means allows the mobile work robot to return to a starting location so as to end its operation in the case where the battery voltage detection means detects a reduction in battery voltage and wherein the travel distance measuring means measures an outer circumference distance of a room and corrects a low limit voltage value, by which the reduction in battery voltage is determined, to an optimum value on the basis of the measured outer circumference distance.

### CITATION LIST

### Patent Literatures

Patent Document 1: Japanese Unexamined Patent Application Publication No. 2002-078650
Patent Document 2: Japanese Unexamined Patent Application Publication No. 2005-135274

### SUMMARY OF INVENTION

### Technical Problems

In the case of a large work area, the traditional self-traveling cleaners would end their operations even though an unclean area is still left, because when to end their operations is determined by an amount of power left in the battery. In the case of a small work area, these self-traveling cleaners would clean an area where was already cleaned several times. Namely, the traditional self-traveling cleaners would not be to clean the work area depending on its size.

This invention is contrived in view of the above-described circumstances and is to provide a self-propelled vacuum cleaner that is capable of determining a work area on the basis of positions of obstacles around the self-propelled vacuum cleaner and is capable of cleaning the work area efficiently depending on its size.

### Solution To Problems

This invention provides a self-propelled vacuum cleaner comprising a housing; traveling members for allowing the housing to travel; cleaning members for cleaning a floor surface; an obstacle detection unit for detecting positions of obstacles present around the housing; and a control unit for controlling the traveling members, the cleaning members and the obstacle detection unit to allow the housing to clean the floor surface while the housing is self-propelled, wherein the control unit controls the obstacle detection unit to detect the positions of the obstacles around the housing and determines a traveling time to clean the floor surface on the basis of the positions of the obstacles.

### Advantageous Effects Of Invention

The self-propelled vacuum cleaner of this invention is capable of determining a traveling area on the basis of the positions of the obstacles around the self-propelled vacuum cleaner and of determining the traveling time that secures certain work efficiency regardless of a size of the traveling area since the control unit controls the obstacle detection unit to detect the positions of the obstacles around the housing and determines the traveling time for cleaning the floor surface on the basis of the positions of the obstacles.

### BRIEF DESCRIPTION OF DRAWINGS

FIG. 1 indicates block diagrams indicating general compositions of the self-propelled vacuum cleaner and of a charging station of this invention. (Embodiment 1)

FIG. 2 is a perspective view briefly illustrating an example of an exterior appearance of the self-propelled vacuum cleaner of FIG. 1.(Embodiment 1)

FIG. 3 indicates a flowchart of preparatory functioning processing carried out by the self-propelled vacuum cleaner of this invention. (Embodiment 1)

FIG. 4 illustrates explanatory drawings indicating preparatory functioning procedures carried out by the self-propelled vacuum cleaner of this invention. (Embodiment 1)

FIG. 5 indicates a flowchart of cleaning functioning processing carried out by the self-propelled vacuum cleaner of this invention. (Embodiment 2)

FIG. 6 illustrates explanatory drawings indicating cleaning functioning procedures carried out by the self-propelled vacuum cleaner of this invention. (Embodiment 2)

FIG. 7 indicates a flowchart of cleaning functioning processing carried out by the self-propelled vacuum cleaner of this invention. (Embodiment 3)

FIG. 8 illustrates explanatory drawings indicating cleaning functioning procedures carried out by the self-propelled vacuum cleaner of this invention. (Embodiment 3)

FIG. 9 illustrates explanatory drawings indicating cleaning functioning procedures carried out by the self-propelled vacuum cleaner of this invention. (Embodiment 4)

### DESCRIPTION OF EMBODIMENTS

In the following, this invention will be described in detail through the use of drawings. Note that the following explanations are exemplifications in all respects and should not be comprehended to limit this invention only to these explanations.

### Embodiment 1

### <Composition of Self-Propelled Vacuum Cleaner>

A self-propelled vacuum cleaner 1 of Embodiment 1 of this invention will be explained.

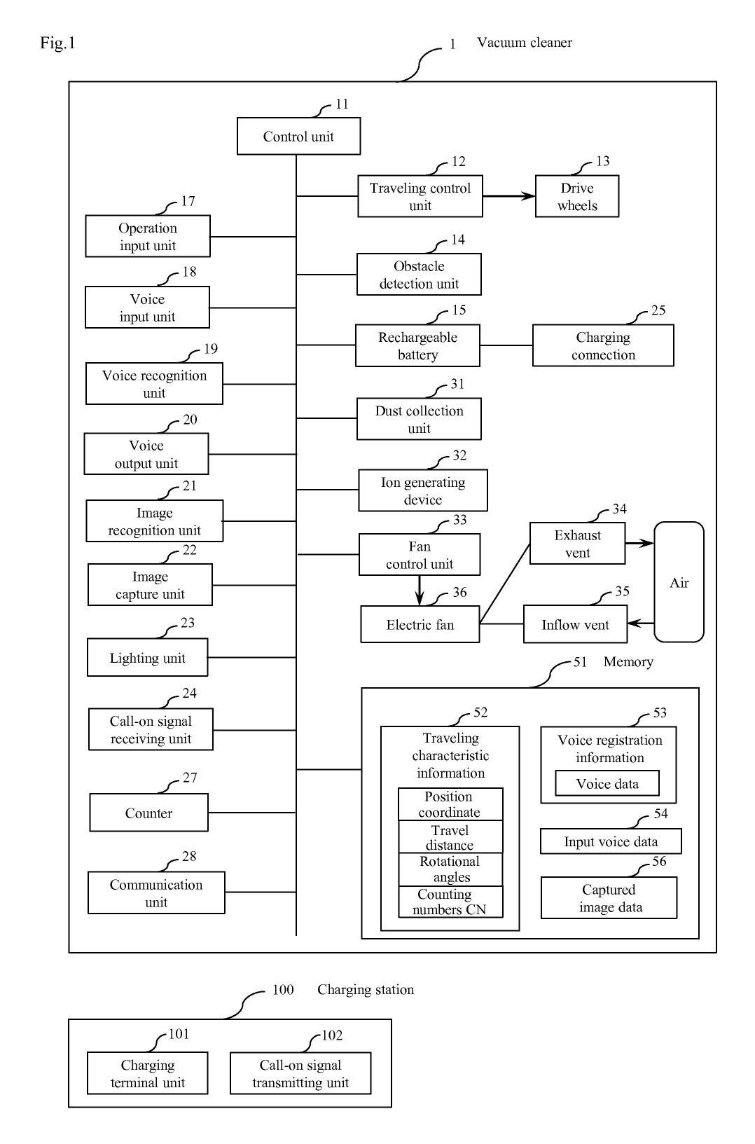

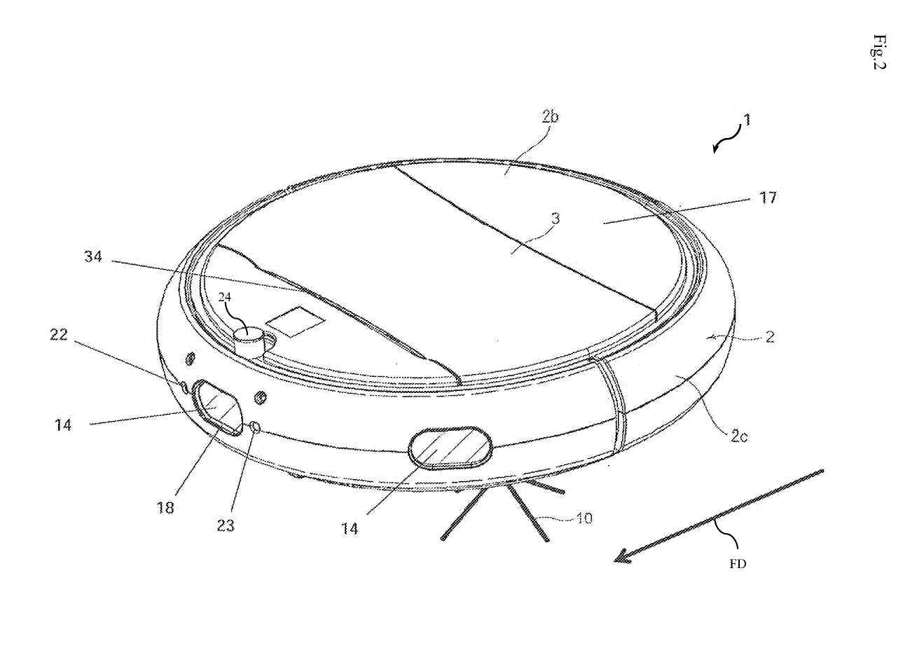

In the following, a composition of the self-propelled vacuum cleaner 1 of this invention will be explained through the use of FIGS. 1 and 2.

FIG. 1 indicates block diagrams indicating general compositions of the self-propelled vacuum cleaner 1 and of a charging station 100 of this invention.

FIG. 2 is a perspective view briefly illustrating an exterior appearance of the self-propelled vacuum cleaner 1 of FIG. 1.

In the following Embodiment, the general composition and functions of the self-propelled vacuum cleaner 1 will be mainly explained.

The self-propelled vacuum cleaner 1 is provided with a housing 2 having an inflow vent 35 disposed at its bottom and a dust collection unit 31 disposed inside the housing; a pair of drive wheels 13 for allowing the housing 2 to travel; and a traveling control unit 12 for controlling the drive wheels 13 in such a way as to rotate, stop, change a direction of the housing, etc.; and the self-propelled vacuum cleaner functions to clean autonomously.

As indicated in FIG. 1, the self-propelled vacuum cleaner 1 of this invention is provided mainly with a control unit 11; the traveling control unit 12; the drive wheels 13; an obstacle detection unit 14; a rechargeable battery 15; an operation input unit 17; a voice input unit 18; a voice recognition unit 19; a voice output unit 20; an image capture unit 22; a lighting unit 23; a call-on signal receiving unit 24; a charging connection 25; a counter 27; a communication unit 28; the dust collection unit 31; an ion-generating device 32; a fan control unit 33; an exhaust vent 34; the inflow vent 35; and a memory 51.

In the following, composition elements indicated in FIG. 1 will be explained.

The self-propelled vacuum cleaner 1 of this invention has the housing 2 that is sterically structured such as a disk-like, pillar-type or cuboid housing; and the housing 2 has the composition elements placed on its surface or inside the housing.

The above-mentioned drive wheels 13, obstacle detection unit 14, operation input unit 17, voice input unit 18, image capture unit 22, lighting unit 23, call-on signal receiving unit 24 and charging connection 25, for example, are placed at positions that are visible from the outside of the housing 2; and the other composition elements are placed inside the housing 2.

The charging station 100 is placed at a predetermined position in a room to be cleaned. The charging station 100 may be placed anywhere that can be supplied with electric power, for example, a position in the vicinity of a wall outlet as a commercial power supply, a wall of the room, or a side of a desk. As indicated in FIG. 1, the charging station 100 is provided with a charging terminal unit 101 and a call-on signal transmitting unit 102. The charging terminal unit 101 of the charging station 100 is to be electrically connected with the charging connection 25 of the self-propelled vacuum cleaner 1 so that the self-propelled vacuum cleaner 1 is supplied with electric power from the charging station 100 and that the rechargeable battery 15 of the self-propelled vacuum cleaner 1 is charged. The self-propelled vacuum cleaner 1 cleans while being self-propelled after disengaging from the charging station 100.

The self-propelled vacuum cleaner 1 of this invention is a cleaning robot for cleaning a floor surface by performing self-propulsion on the floor surface of a place to be cleaned while sucking in air containing dust on the floor surface and blowing out air after removing the dust. The self-propelled vacuum cleaner 1 of this invention has a function for returning to the charging station 100 autonomously after cleaning the floor surface.

As illustrated in FIG. 2, the self-propelled vacuum cleaner 1 is provided with the disk-like housing 2; and this housing 2 is provided outside and inside with a top board 2b; a side plate 2c; a cover 3; a rotary brush; side brooms 10; the drive wheels 13 allowing self-propulsion; the obstacle detection unit 14; the operation input unit 17; the voice input unit 18; the voice output unit 20; the image capture unit 22; the lighting unit 23; wheels (not illustrated) including a front wheel and a rear wheel that follow a wheel drive of the drive wheels; the call-on signal receiving unit 24; the communication unit 28 (not illustrated); the dust collection unit 31 (not illustrated); the ion-generating device 32 (not illustrated); the exhaust vent 34; an electric fan 36; and the other composition elements indicated in FIG. 1.

In FIG. 2, a part where the obstacle detection unit 14 is placed is referred to as a front part of the housing 2; a part where the cover 3 is placed is referred to as a middle part; and a part that is placed on opposite side of the front part across the middle part is referred to as a rear part. Note that the front stands for a forward direction FD of the self-propelled vacuum cleaner 1, and the forward direction is indicated by an arrow in FIG. 2; and a direction opposite from the forward direction FD of the self-propelled vacuum cleaner 1 is the rear.

The housing 2 is provided with a bottom plate in a round shape from a planar view, that is placed on the back side (a lower surface) and has the inflow vent 35 (see FIG. 1) provided with the rotary brush; the top board 2b having the cover 3 disposed at its midsection, the cover being configured to open and close so that the dust collection unit 31 can be pulled out of or inserted into the housing 2; and the side plate 2c in the form of a ring from a planar view disposed along outer peripheries of the bottom plate and of the top board 2b. The bottom plate is provided with openings for allowing lower parts of the front wheel in the front, of the pair of drive wheels 13 in the middle part, and of the rear wheel in the rear, to project from the housing 2; and the top board 2b is provided with the exhaust vent 34 near a border between the front part and the middle part. The side plate 2c is divided into two portions in front and behind, and the front portion of the side plate 2c functions as a bumper.

The self-propelled vacuum cleaner 1 senses a signal emitted from the call-on signal transmitting unit 102 of the charging station 100 by means of the call-on signal receiving unit 24 and recognizes where the charging station 100 is located so as to travel autonomously back and return to the charging station 100 after, for example, any of the following: The cleaning is completed; the rechargeable battery 15 becomes low on battery charge; or a set time of a cleaning timer elapses. The self-propelled vacuum cleaner travels back to the charging station 100 as avoiding obstacles on the way back to the charging station.

In the following, a control section of the self-propelled vacuum cleaner 1 in FIG. 1 will be explained.

The control unit 11 in FIG. 1 is to control functions of the composition elements of the self-propelled vacuum cleaner 1; and a microcomputer substantially controls the functions, which comprises mainly CPU, ROM, RAM, an I/O controller, a timer, etc.

CPU carries out a sensing function, a calculating function, a driving function, etc. to be described below by organically operating hardware on the basis of a previously-installed control program in ROM, etc.

The drive wheels 13 are placed, for example, at a bottom part of the housing 2 and allow the housing 2 to travel.

The traveling control unit 12 is to control the self-propelled vacuum cleaner 1 to travel autonomously and is to allow the housing 2 to travel autonomously by controlling rotations mainly of the drive wheels 13.

The traveling control unit 12 is to control the self-propelled vacuum cleaner 1 to travel forward, travel backward, rotate, stop, etc. by driving or stopping the pair of drive wheels 13. The drive wheels 13 and the traveling control unit 12 are exemplifications of traveling members of the present invention.

The obstacle detection unit 14 is to detect any obstacles present around the self-propelled vacuum cleaner 1, such as a desk and a chair, by means of, for example, a range instrumentation sensor such as an ultrasonic sensor or an infrared range instrumentation sensor and is placed at the front part of the housing 2. The self-propelled vacuum cleaner may be provided with two or more obstacle detection units 14.

CPU of the control unit 11 recognizes a position of an obstacle on the basis of a signal outputted from the obstacle detection unit 14. The self-propelled vacuum cleaner avoids the obstacle on the basis of the location information on the recognized obstacle and determines what way to travel next.

In addition to the obstacle detection unit 14, the self-propelled vacuum cleaner 1 may be provided with a collision sensor that is to sense a collision of the self-propelled vacuum cleaner 1 with an obstacle.

The rechargeable battery 15 is to supply electric power to the composition elements of the self-propelled vacuum cleaner 1 and is to carry out mainly a photographing function, a travel control, etc. Used as the rechargeable battery is a lithium-ion battery, a nickel-metal-hydride battery, an Ni—Cd battery, or the like.

The rechargeable battery 15 is charged by connecting the self-propelled vacuum cleaner 1 with the charging station 100.

The self-propelled vacuum cleaner 1 is connected with the charging station 100 by electrically connecting the exposed charging connection 25 as a connection section with the charging terminal unit 101.

The operation input unit 17 is a member where a user inputs a directive for how the self-propelled vacuum cleaner 1 should function; and the operation input unit is provided, as an operating panel or a manual operation button, on a surface of the housing 2 of the self-propelled vacuum cleaner 1-for example, on a top panel in the rear part of the housing 2 as illustrated in FIG. 2.

The self-propelled vacuum cleaner may have a remote control as an accessary that sends infrared light or a radio signal as its manual operation button is pressed so that a directive is sent as radio communications that prescribes how the self-propelled vacuum cleaner should function.

The operation input unit 17 comprises, for example, an on/off button, a start-up button, a charging request button, and other buttons (such as an operation mode button and a timer button).

The voice input unit 18 is a member where a human voice(s) or a sound(s) (hereinafter referred to collectively as a voice(s)) is inputted through, for example, a microphone.

A voice inputted into the voice input unit 18 undergoes, for example, an analog-to-digital conversion and is stored as an input voice data 54 in the memory 51 in a predetermined digital voice format.

The voice recognition unit 19 is to recognize the inputted voice. Namely, the voice recognition unit recognizes a word(s) or a sentence(s)from the voice (the input voice data 54) inputted into the voice input unit 18. The voice recognition unit may be configured to recognize a person who uttered the voice. To recognize the voice, voice registration information 53is stored in the memory 51 in advance. The voice registration information 53 contains, for example, samples of voice data.

The voice output unit 20 is to output a voice in response to a user's voice, a voice to make communication with a user, etc. through a speaker. The voice output unit 20 is placed at a side of the front part of the housing 2 of the self-propelled vacuum cleaner 1. This, however, is merely an exemplification; and the voice output unit may be placed anywhere.

The voice recognition unit 19 carries out pattern matching processing for determining whether the input voice data 54 match with the voice data stored in the voice registration information 53. More specifically, in the case where the voice data in the voice registration information 53 have voice data that meet predetermined determination criteria with a high matching degree, the control unit 11 controls the composition elements of the self-propelled vacuum cleaner 1 to function in accordance with the voice data of the voice registration information.

For example, in the case where an input voice data 54 indicating “clean up” is inputted into the voice input unit 18, the pattern matching processing for determining whether the input voice data 54 matches with the previously-stored voice data in the voice registration information 53 is carried out so as to allow the composition elements to function (for example, to clean up)in accordance with the voice data that is determined to match with the input voice data 54.

The image capture unit 22 is to capture an image outside the housing 2 by, for example, a camera. As illustrated in FIG. 2, the housing 2 has one image capture unit 22 placed at its front part in a forward direction that the self-propelled vacuum cleaner ordinarily travels. The housing 2 may have two image capture units 22 placed on both sides of the housing 2 at its front part to measure a distance to an object.

An image recognition unit 21 is to recognize the captured image. The image recognition unit recognizes and specifies a sign or a person in the image (captured image data 56) captured by the image capture unit 22 to be described.

An image captured by the image capture unit 22 undergoes, for example, an analog-to-digital conversion and is stored as a captured image data 56 in the memory 51 in a predetermined digital image format.

An image to be captured may be a still image or a moving image. A captured still image is stored as a captured image data 56 in the memory 51.

The lighting unit 23 is to illuminate a surrounding area of the self-propelled vacuum cleaner 1 with, for example, LED. The lighting unit 23 is configured to coordinate, for example, with the camera and lights up before the camera starts shooting.

The call-on signal receiving unit 24 is an infrared sensor for receiving an infrared ray such as a beacon and is placed at the front part of the housing 2. The call-on signal receiving unit 24 receives a location identification signal (beacon) emitted from the call-on signal transmitting unit 102 such as LED placed on the charging station 100.

LED used as the call-on signal transmitting unit 102 may be partially covered to control an emission range of a location identification signal. For example, LED having an emission angle of about 30 to 40 degrees may be partially covered to have a desired emission angle of a location identification signal.

The counter 27 is to count encoding signals read on the basis of a rotational angle(s) of a motor(s) for driving the drive wheels 13. As long as the drive wheels 13 are driven by pulse motors, their pulses may be counted as well as pulses of an encoder that reads the encoding signals on the basis of the rotational angle(s) of the motor(s). In the case where rotational angles are proportional to counting numbers CN counted by the counter 27 during rotation of the drive wheels 13, and the drive wheels 13 do not skid on a floor surface, a travel distance of the housing 2 is proportional to the rotational angles of the drive wheels 13, with the result that the travel distance of the housing 2 may be estimated from the counting numbers CN.

The communication unit 28 is to make electronic communications with an external device through a network. Namely, the communication unit transmits a variety of information to the external device other than the self-propelled vacuum cleaner 1 and receives data such as an operation request from the external device.

Used as the network may be either a wide area network (WAN) such as LAN or the Internet or a customized communication line.

Examples of a wireless communication standard include IEEE802.11a, IEEE802.11b, IEEE802.11g and IEEE802.11n used as standards of Bluetooth™ and a wireless LAN.

In the case where the communication unit receives an image shooting request from the external device, and the image shooting request meets predetermined image transmission requirements, the communication unit 28 transmits a captured image data 56 captured by the image capture unit 22 to the external device. Examples of the external device include PC, a portable terminal and a server (all of which are not illustrated).

The dust collection unit 31 is to carry out a cleaning function for collecting trash and dust in a room and comprises mainly a dust collection cup, a filter, and an openable and closable cover for covering the dust collection cup and the filter (all of which are not illustrated).

The dust collection cup 31 has an inflow passage connecting with the inflow vent 35 and a discharge passage connecting with the exhaust vent 34, and air sucked through the inflow vent 35 passes through the inflow passage and flows into the dust collection cup so that the air is blown into the exhaust passage through the filter and is discharged out of the exhaust vent 34. The dust collection unit is also provided with the fan control unit 33 for driving the electric fan 36 so as to flow the air.

The dust collection unit 31 is not controlled by the control unit 11 and is to transmit to the control unit 11 a sensing signal sent from sensing means (a mechanical switch, a photo detection switch, etc.) for sensing whether the dust collection unit 31 is installed in a container of the cleaner.

The ion-generating device 32 is contained inside the housing 2 and is to generate ions.

More specifically, the ion-generating device ionizes water molecules in the air by electric discharge to generate H⁺(H₂O₎ₘ (^{m} is any of non-negative integers) as positive ions and O₂⁻(H₂O)ₙ (ₙ is any of non-negative integers) as negative ions.

The ion-generating device 32 is provided at the discharge passage with ion-dischargers for discharging the positive ions and the negative ions, respectively.

The ions to be generated are not particularly limited; however, examples of the ions include ions capable of cleansing air and ions having effects of making the skin beautiful and of inhibiting the growth of bacteria on a skin surface; and the traditionally-used plasma cluster ions™ may be used as described above. The ion-generating device 32 is provided as, for example, a small, cuboid ion-generating member.

The ions to be generated may be either the negative ions or the positive ions. The ions may contain electrically-charged particulate water droplets obtained by an electrostatic vaporizing phenomenon. The negative ions in particular are capable of giving a relaxing effect to a user.

The fan control unit 33 is mainly to drive and control a blast fan for sucking in air through the inflow vent 35.

The ions generated by the ion-generating device 32 are discharged into clean air that has passed through the filter of the dust collection unit 31 and are blown out of the exhaust vent 34 together with the air.

The exhaust vent 34 is provided at, for example, the top surface of the housing 2 and is an opening for discharging the ion-containing air generated by the ion-generating device 32 into the outside. The ion-containing air may be discharged obliquely upward toward the back of the housing through the top surface of the housing 2.

As described above, the self-propelled vacuum cleaner 1 sucks in the dust on the floor surface together with the outside air through the inflow vent 35and separates the dust in the dust collection unit 31 to blow out the air, from which the dust is removed, together with the ions through the exhaust vent 34, with the result that the self-propelled vacuum cleaner brings about effects of cleaning the floor surface and of cleansing the air by blowing out and spreading the ions to the room.

The above are to describe the self-propelled vacuum cleaner 1, and a self-propelled ion generator without a cleaning function may have the inflow vent 35 placed at the top board 2b but not at a bottom plate. In this case, the self-propelled ion generator is not provided with the dust collection unit 31 but is provided at a passage between the inflow vent 35 and the exhaust vent 34 with a filter for removing dust in the air. The self-propelled ion generator may have the exhaust vent 34 as illustrated in FIG. 2 but may have the inflow vent 35 placed at a position different from where the exhaust vent 34 is placed.

This ion generator is provided at the exhaust vent 34 with an openable and closable cover for exhaust so as to prevent foreign objects, dirt, dust, etc. from entering the ion generator through at least the exhaust vent 34 when the ion generator is not in operation to generate ions. The ion generator may be provided also at the inflow vent 35 with an openable and closable cover for sucking if need arises.

Besides the above-described ion generator, an air cleaner may be configured that is not provided with the ion-generating device 32 but may be provided with a filter for removing dust in the air flowing from the inflow vent 35 to the exhaust vent 34 to cleanse air by driving a blast fan. Needless to say, this invention includes such an apparatus fulfilling these functions and roles.

The memory 51 is to store the information and/or a program necessary to carry out the functions of the self-propelled vacuum cleaner 1, and used as the memory is a semiconductor device such as RAM or ROM or a memory medium such as a hard disk or a flash memory.

The memory 51 stores mainly the traveling characteristic information 52, the input voice data 54, the captured image data 56, etc. The memory also temporarily stores functions such as a voice recognition function, a photographing function and a communication function, and the information necessary to carry out other functions.

The traveling characteristic information 52 is data on traveling characteristics of the housing 2 such as a position coordinate, a travel distance, counting numbers CN and rotational angles at the time of changing a direction.

The travel distance and the rotational angles of the housing 2 are stored as the traveling characteristic information 52—the travel distance is indicated as the counting numbers CN that are required for the traveling, and the rotational angles are indicated as the counting numbers CN that are required for the rotation.

In this way, a travel record of the self-propelled vacuum cleaner 1 may be stored in the memory 51. The memory 51, however, is merely an exemplification of a travel record storage of the present invention.

The memory stores the voice registration information 53 in advance such as a word(s) to be recognized, voice data on the word(s), and the information specifying a name(s) of a person(s) who utter(s), all of which are correlated with each other.

The voice registration information 53 is stored in advance including a registered word(s), voice data and a name(s) of a person(s) who utter(s), all of which are correlated with each other.

To specify a person, this person's name needs to be registered, whereas only to recognize a word and not to specify a person who utters the word, this person's name needs not be registered.

The voice data are stored as one voice file containing the analog waveform information or the digital information such as the waveform information, the frequency information, a voice library and the registered word information.

The input voice data 54 are voice or sound data -for example, digitalized acoustic data—inputted into the voice input unit 18.

The captured image data 56 are an image captured by the image capture unit 22. The image may be either a still image or a moving image.

### <Specific Examples of Preparatory Functioning Procedures Carried Out by Self-Propelled Vacuum Cleaner>

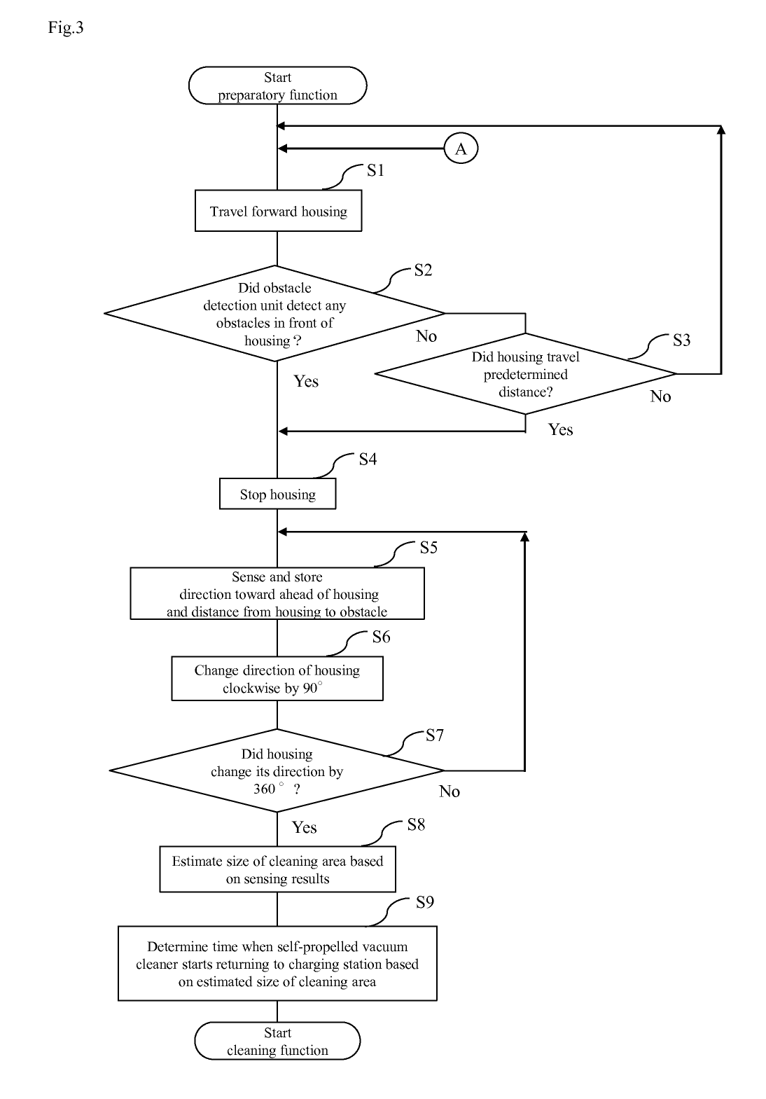

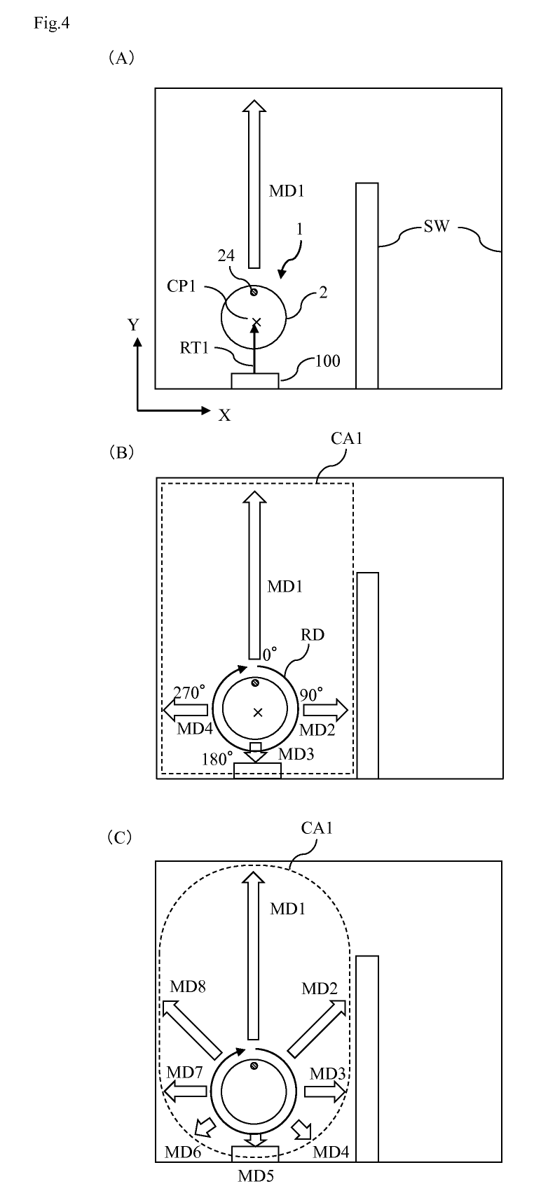

The following explain specific examples of preparatory functioning procedures carried out by the self-propelled vacuum cleaner 1 through the use of FIGS. 3 and 4.

FIG. 3 indicates a flowchart of preparatory functioning processing carried out by the self-propelled vacuum cleaner 1 of this invention.

FIG. 4 illustrates explanatory drawings indicating the preparatory functioning procedures carried out by the self-propelled vacuum cleaner 1 of this invention.

In FIGS. 4(B) and (C), reference signs that are used in FIG. 4(A) are omitted.

Embodiment 1 explains how the self-propelled vacuum cleaner 1 determines a cleaning area CA1 during the preparatory function before the cleaning, where the vacuum cleaner is self-propelled.

After starting the preparatory function, the control unit 11 carries out procedures indicated in the following steps.

In step S1 indicated in FIG. 3, the control unit 11 controls the housing 2 to travel forward (step S1).

At the start of the preparatory function, as illustrated in FIG. 4 (A), the housing 2 of the self-propelled vacuum cleaner 1, which was connected with the charging station 100 installed on a side wall SW, travels from the charging station 100 through a course RT1 indicated by an arrow in response to a call-on signal transmitted from the call-on signal transmitting unit 102 of the charging station 100. The self-propelled vacuum cleaner 1 needs not necessarily travel through the course in response to the call-on signal.

FIG. 4(A) exemplifies that a room is enclosed with side walls SW to make the room rectangular and to have a partition that is placed in the middle of the room and extends in a direction of the y-axis. Note that a direction along the side wall SW where the charging station 100 is installed is referred to as the x-axis, and a direction perpendicular to the x-axis is referred to as the y-axis.

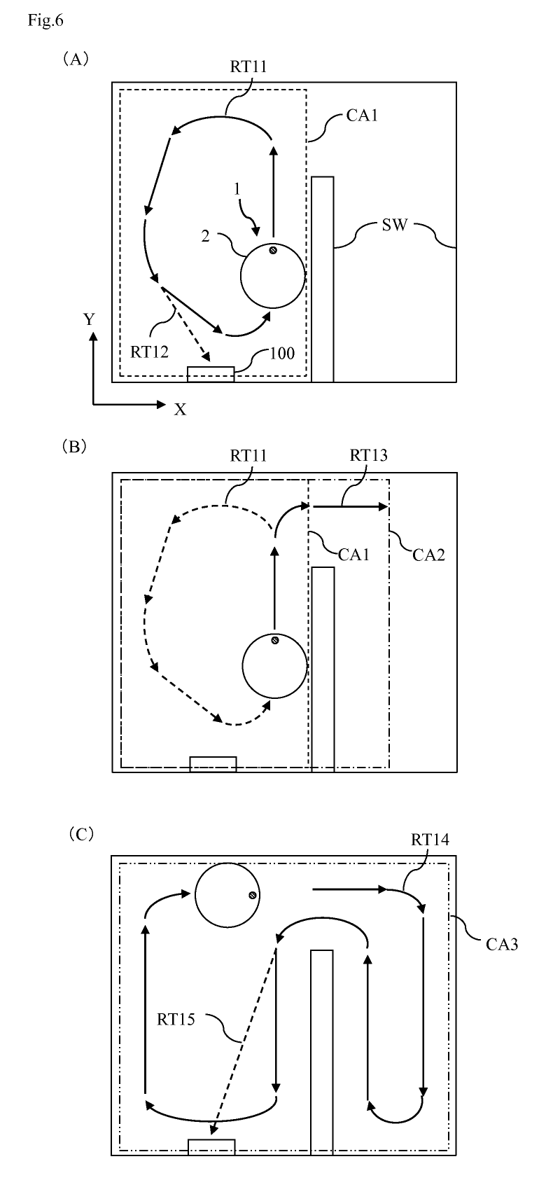

The same applies to FIGS. 6, 8 and 9.

In step S2, the control unit 11 determines whether the obstacle detection unit 14 detects any obstacle in front of the housing 2 (step S2).

In the case where the obstacle detection unit 14 does not detect any obstacle in front of the housing 2 (in the case of determining “No” in step S2), the control unit 11 moves on to step S3.

In the case where the obstacle detection unit 14 detects an obstacle in front of the housing 2 (in the case of determining “Yes” in step S2), the control unit 11 moves on to step S4.

In step S3, the control unit 11 determines whether the housing 2 travels a predetermined distance (e.g., 2 m) from the charging station 100 (step S3).

In the case where the housing 2 travels the predetermined distance from the charging station 100 (in the case of determining “Yes” in step S3), the control unit 11 moves on to step S4.

In the case where the housing 2 does not travel the predetermined distance from the charging station 100 (in the case of determining “No” in step S3), the control unit 11 goes back to step S1.

In step S4, the control unit 11 brings the housing 2 to a stop so as to detect any obstacle present around the housing (step S4).

The obstacle detection unit may detect an obstacle not only from one position but also from several positions. Detecting the obstacle from the several positions makes it possible to detect its position accurately even if the obstacle detection unit 14 is low in detecting accuracy. For example, the obstacle detection unit may detect an obstacle every 2 m the housing 2 travels from the charging station 100 in a large room.

In step S5, the control unit 11 controls the obstacle detection unit 14 to sense a direction toward ahead of the housing 2 and a distance from the housing 2 to the obstacle and stores the information in the memory 51 (step S5).

In this case, the control unit 11 stores a distance L1 from the obstacle detection unit 14 to the obstacle in front of the housing 2 by regarding the moving direction of the housing (a y-axis positive direction) extending along the course RT1 as a reference direction as illustrated in FIG. 4(A).

In step S6, the control unit 11 controls the housing 2 to change its direction clockwise by 90° from the reference direction (step S6).

In this case, the housing 2 changes its direction clockwise (an RD direction) by 90° from the reference direction (the y-axis positive direction) as illustrated in FIG. 4(B).

In step S7, the control unit 11 determines whether the housing 2 changes its direction by 360° from the reference direction (step S7).

In the case where the housing 2 changes its direction by 360° from the reference direction (in the case of determining “Yes” in step S7), the control unit 11 moves on to step S8.

In the case where the housing 2 does not change its direction by 360° from the reference direction (in the case of determining “No” in step S7), the control unit 11 goes back to step S5 and carries on detecting any obstacle.

As illustrated in FIG. 4(B), in the case where the housing 2 turns to a direction 90° (an x-axis positive direction) from the reference direction, the control unit 11 stores in the memory 51 the direction of the housing and a distance L2 from the obstacle detection unit 14 to an obstacle in front of the housing 2.

In a similar manner, in the case where the housing 2 turns to a direction 180° (a y-axis negative direction) from the reference direction, the control unit 11 stores in the memory 51 the direction of the housing and a distance L3 from the obstacle detection unit 14 to an obstacle in front of the housing 2; and in the case where the housing 2 turns to a direction 270° (an x-axis negative direction) from the reference direction, the control unit stores in the memory 51 the direction of the housing and a distance L4 from the obstacle detection unit 14 to an obstacle in front of the housing 2.

Table 1 below indicates an exemplification of results thereby obtained.

TABLE 1

| | | Distance (m) |
|---|---|---|
| Sensed direction | Rotational angle (°) of the housing 2 | to obstacle |
| MD1 | 0° (y-axis positive direction) | L1 |
| MD2 | 90° (x-axis positive direction) | L2 |
| MD3 | 180° (y-axis negative direction) | L3 |
| MD4 | 270° (x-axis negative direction) | L4 |

In Table 1 above, each of the sensed directions indicates the direction toward ahead of the housing 2; and the sensed directions are indicated by arrows MD1 to MD4, respectively, in FIG. 4(B). The rotational angle indicates an angle based on the direction (that is taken along the course RT1 illustrated in FIG. 4(A)) of the housing 2 that left the charging station 100 and traveled to a cleaning area. The distance to the obstacle indicates a distance (m) from the obstacle detection unit 14 to the obstacle in front of the housing 2.

Table 1 indicates as follows: In the case where the housing 2 turns to the direction (the y-axis positive direction; the rotational angle of 0°) indicated by the arrow MD1, the distance to the obstacle is indicated by L1; in the case where the housing 2 turns to the direction (the x-axis positive direction; the rotational angle of 90°) indicated by the arrow MD2, the distance to the obstacle is indicated by L2; in the case where the housing 2 turns to the direction (the y-axis negative direction; the rotational angle of 180°) indicated by the arrow MD3, the distance to the obstacle is indicated by L3; and in the case where the housing 2 turns to the direction (the x-axis negative direction; the rotational angle of 270°) indicated by the arrow MD4, the distance to the obstacle is indicated by L4.

The rotational angle of the housing 2 does not need to be changed by every 90° as illustrated in FIG. 4(B) but may be changed by any angle. For example, the rotational angle of the housing 2 may be changed by every 45°. Moreover, the housing 2 does not need to make a stop to detect obstacles and may continue rotating to detect the obstacles at a predetermined timing (for example, making detections 10 times a second).

The housing 2 may be provided at its side surface with several obstacle detection units 14 to detect several obstacles present around the housing 2 at the same time. For example, the housing 2 may be provided at its front part with three obstacle detection units 14 that are separated from each other by a sensing angle of 40° so as to detect obstacles present in three directions at the same time.

The housing 2 needs not necessarily rotate and change its direction to detect obstacles and may be provided, for example, at its front, rear, right and left with obstacle detection units 14 so as to detect the obstacles in front, rear, right and left directions at the same time without changing the direction. The housing may not be provided with the obstacle detection unit 14 to detect an obstacle but may use the image recognition unit 21 to analyze an image captured by the image capture unit 22 and to sense a distance and a direction to the obstacle.

In the case where the housing 2 travels from the charging station 100 for a predetermined distance to detect an obstacle, the housing 2 may omit sensing a direction to the charging station 100. In the case where a room is symmetrical, and the charging station 100 is placed in the middle of a side wall, the housing may sense either only one of the right-hand side and the left-hand side of the room viewed from the charging station 100.

In step S8, the control unit 11 estimates a size of a cleaning area where the vacuum cleaner is self-propelled on the basis of the sensing results obtained in step S5 to step S7 (step S8).

A specific size of the cleaning area—such as the rectangular cleaning area CA1 as illustrated in FIG. 4(B)—may be estimated as indicated in Table 2 below, provided that a diameter of the housing 2 is considered as LD (m).

TABLE 2

| | |
|---|---|
| Length in the x-axis direction | LD + L2 + L4 (m) |
| Length in the y-axis direction | LD + L1 + L3 (m) |
| Estimated size of the cleaning | (LD + L2 + L4) × (LD + L1 + L3) (m²) |
| area CA1 | |

In step S9, the control unit 11 determines on the basis of the estimated size of the cleaning area a traveling time of the self-propelled vacuum cleaner 1 from a time when the self-propelled vacuum cleaner starts cleaning to a time when the self-propelled vacuum cleaner starts returning to the charging station 100 (step S9).

A specific traveling time of the self-propelled vacuum cleaner may be determined by the control unit 11 with reference to a correlation between an estimated size (m²) of the cleaning area and a traveling time (minute) as indicated in Table 3 below.

In the case where the cleaning area CA1 is rectangular as illustrated in FIG. 4(B), an estimated size EA1 of the cleaning area is calculated by multiplying a length in the x-axis direction by a length in the y-axis direction—namely, EA1=(LD+L2+L4)×(LD+L1+L3). In the case where the estimated size EA1 is approximately 24 (m²) that is within a range from 20 to 30 (m²), a traveling time is found to be 40 minutes with reference to the correlation indicated in Table 3.

TABLE 3

| Estimated size (m²) | Traveling time (min.) |
|---|---|
| 0-10 | 5 |
| 10-20 | 20 |
| 20-30 | 40 |
| 30-40 | 50 |
| 40-50 | 60 |

Note that the correlation indicated in Table 3 is calculated, for example, from an estimated size of a cleaning area where the self-propelled vacuum cleaner 1 is self-propelled randomly and an average time that the self-propelled vacuum cleaner 1 requires to travel 99% or more of the cleaning area.

Used as the estimated size may be a size of a Japanese-style room such as a 4.5-, 6- or 8-tatami mat room.

Finally, following the determination of the traveling time, the control unit 11 self-propels the housing 2 to carry out the cleaning function randomly during the traveling time.

The self-propelled vacuum cleaner 1 is self-propelled randomly in the cleaning area CA1 and returns to the charging station 100 after a lapse of the traveling time.

As described above, the control unit may determine during the preparatory function a cleaning area, where the self-propelled vacuum cleaner 1 would be possibly self-propelled, on the basis of positions of obstacles present around the self-propelled vacuum cleaner and may estimate an optimal traveling time from an estimated size of the cleaning area.

### Altered Example of Embodiment 1

In the following, an altered example of Embodiment 1 will be explained.

Embodiment 1 exemplifies the rectangular cleaning area CA1, whereas the altered example of Embodiment 1 exemplifies an oval area CA1 as illustrated in FIG. 4(C). In this case, the housing 2 rotates to measure several directions (such as eight (8) directions MD1 to MD8 as illustrated in FIG. 4(C)) and detects positions of obstacles so as to determine a size of the oval cleaning area CA1. The housing then determines a traveling time on the basis of the size of the oval cleaning area CA1.

Such exemplification makes the oval cleaning area CA1 more practical or realistic than the rectangular cleaning area CA1.

### Embodiment 2

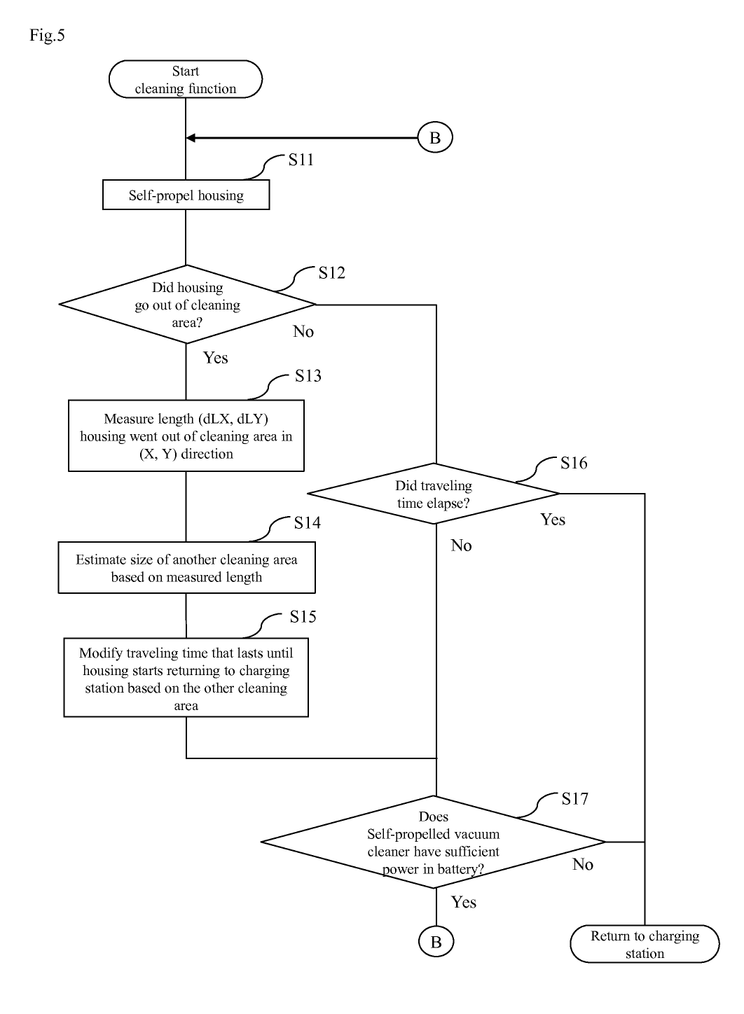

The following explain specific examples of cleaning functioning procedures carried out by the self-propelled vacuum cleaner 1 of Embodiment 2 through the use of FIGS. 5 and 6.

FIG. 5 indicates a flowchart of cleaning functioning processing carried out by the self-propelled vacuum cleaner 1 of this invention.

FIG. 6 illustrates explanatory drawings indicating the cleaning functioning procedures carried out by the self-propelled vacuum cleaner 1 of this invention.

In FIGS. 6(B) and (C), reference signs that are used in FIG. 6(A) are omitted.

Embodiment 2 explains a case where the self-propelled vacuum cleaner 1 goes out of a cleaning area CA1 while traveling randomly.

In Embodiment 2, the control unit 11 carries out procedures indicated in the following steps after the self-propelled vacuum cleaner 1 starts the cleaning function.

In step S11 indicated in FIG. 5, the control unit 11 self-propels the housing 2 to travel randomly (step S11).

In step S12, the control unit 11 determines whether the housing 2 goes out of the cleaning area while being self-propelled (step S12).

Whether the housing 2 goes out of the cleaning area may be determined by calculating a coordinate based on the charging station 100. In the case where a rectangular cleaning area CA1 is exemplified to be −2 m to +2 m wide in the x-axis direction and +0 m to +6 m long in the y-axis direction that are measured from the charging station 100 (as an original point) as illustrated in FIG. 6(A), and a position coordinate of the housing 2 goes out of an x-y coordinate of the cleaning area CA1 while the housing is self-propelled, it is determined that the housing 2 has gone out of the cleaning area CA1.

In the case where the housing 2 does not go out of the cleaning area while being self-propelled in step S12 (in the case of determining “No” in step S12), the control unit 11 moves on to step S16.

In the case where the housing 2 goes out of the cleaning area while being self-propelled (in the case of determining “Yes” in step S12), the control unit 11 moves on to step S13.

In step S16, the control unit 11 determines whether the traveling time, which was determined during the preparatory function, elapses (step S16).

In the case where the traveling time elapses (in the case of determining “Yes” in step S16), the control unit 11 controls the housing 2 to return to the charging station 100.

In the case where the traveling time does not yet elapse (in the case of determining “No” in step S16), the control unit 11 moves on to step S17.

The housing 2 of the self-propelled vacuum cleaner 1 is assumed to travel through a course RT11 in the cleaning area CA1 as illustrated in FIG. 6(A). During the traveling time, the self-propelled vacuum cleaner 1 continues to be self-propelled; however, once the traveling time elapses, the self-propelled vacuum cleaner immediately ends the random traveling and travels through a course RT12 to return to the charging station 100.

In step S13, the control unit 11 measures a length (dLX, dLY) of how far the housing 2 goes out of the cleaning area in an x-y direction (step S13).

FIG. 6(B) exemplifies that the housing 2 goes out of the cleaning area CA1 and travels through a course RT13, with the result that the housing goes out of the cleaning area CA1 by 2 m in the x-axis positive direction. In this case, a length (dLX, dLY) of how far the housing goes out of the cleaning area is indicated as (2 m, 0) in the x-y direction.

In step S14, the control unit 11 estimates a size of another cleaning area on the basis of the length (dLX, dLY) measured in step S13 (step S14).

A specific size of the other cleaning area—such as a rectangular cleaning area CA2 as illustrated in FIG. 6(B)—may be estimated as indicated in Table 4 below, provided that a diameter of the housing 2 is considered as LD (m).

TABLE 4

| | |
|---|---|
| Length in the x-axis direction | LD + L2 + L4 + dLX (m) |
| Length in the y-axis direction | LD + L1 + L3 + dLY (m) |
| Estimated size of the cleaning area | (LD + L2 + L4) × (LD + L1 + L3) |
| CA1 and the other cleaning area CA2 | (m²) |

In step S15, the control unit 11 modifies, on the basis of the other cleaning area, the traveling time that lasts until the housing starts returning to the charging station (step S15).

More specifically, a renewed traveling time is obtained on the basis of the size of the other cleaning area and the correlation indicated in Table 3.

In the case where the cleaning area CA2 is rectangular as illustrated in FIG. 6(B), an estimated size EA2 of this cleaning area is calculated by multiplying a length in the x-axis direction by a length in the y-axis direction—namely, EA1=(LD+L2+L4+dLX)×(LD+L1+L3+dLY). In the case where the estimated size EA2 is approximately 36 (m²) that is within a range from 30 to 40 (m²), a traveling time is found to be 50 minutes with reference to the correlation indicated in Table 3.

As a result, the traveling time of the self-propelled vacuum cleaner 1 is renewed from 40 minutes corresponding to the size of the cleaning area CA1 to 50 minutes corresponding to a total size of both the cleaning area CA1 and the other cleaning area CA2.

As described above, the self-propelled vacuum cleaner 1 of Embodiment 2 renews a cleaning area every time the housing 2 goes over to another area while being self-propelled, with the result that the self-propelled vacuum cleaner is capable of modifying its traveling time in real time on the basis of a size of the renewed cleaning area.

In step S17, the control unit 11 confirms whether the self-propelled vacuum cleaner 1 has sufficient power in a battery with reference to an amount of the power left in the battery (step S17).

In the case where sufficient power is left in the battery (in the case of determining “Yes” in step S17), the control unit 11 goes back to step S11 and controls the self-propelled vacuum cleaner 1 to continue the cleaning function.

In the case where power is not sufficient in the battery (in the case of determining “No” in step S17), the control unit 11 controls the housing 2 to return to the charging station 100.

Note that the larger an estimated size of a cleaning area, the more power the self-propelled vacuum cleaner 1 requires to return to the charging station 100; therefore, determination criteria for determining how much power should be left in the battery may be changed depending on the estimated size of the cleaning area.

In this way, timing for the self-propelled vacuum cleaner 1 to return to the charging station 100 may be properly configured depending on the estimated size of the cleaning area.

The self-propelled vacuum cleaner 1 is assumed to travel through a random course RT14 in a rectangular cleaning area CA3 as illustrated in FIG. 6(C). In the case where an estimated size of the cleaning area CA3 is approximately 42 (m²), a traveling time is found to be 60 minutes with reference to the correlation indicated in Table 3.

In the case where the self-propelled vacuum cleaner cleans several cleaning areas, a total estimated size of these cleaning areas maybe estimated in consideration of a length of a side wall SW between the two cleaning areas.

In the case where the self-propelled vacuum cleaner is low on power in the battery while self-propelling the housing, the self-propelled vacuum cleaner 1 immediately ends the random traveling and travels through a course RT15 to return to the charging station 100 as illustrated in FIG. 6(C).

This Embodiment explains that the self-propelled vacuum cleaner 1 modifies the estimated size of the cleaning area(s) and the traveling time of the self-propelled vacuum cleaner on the basis of how far the housing 2 goes out of the cleaning area but is not limited to this. For example, the self-propelled vacuum cleaner may modify an estimated size and a traveling time on the basis of how long the housing goes out of the traveling area.

### Embodiment 3

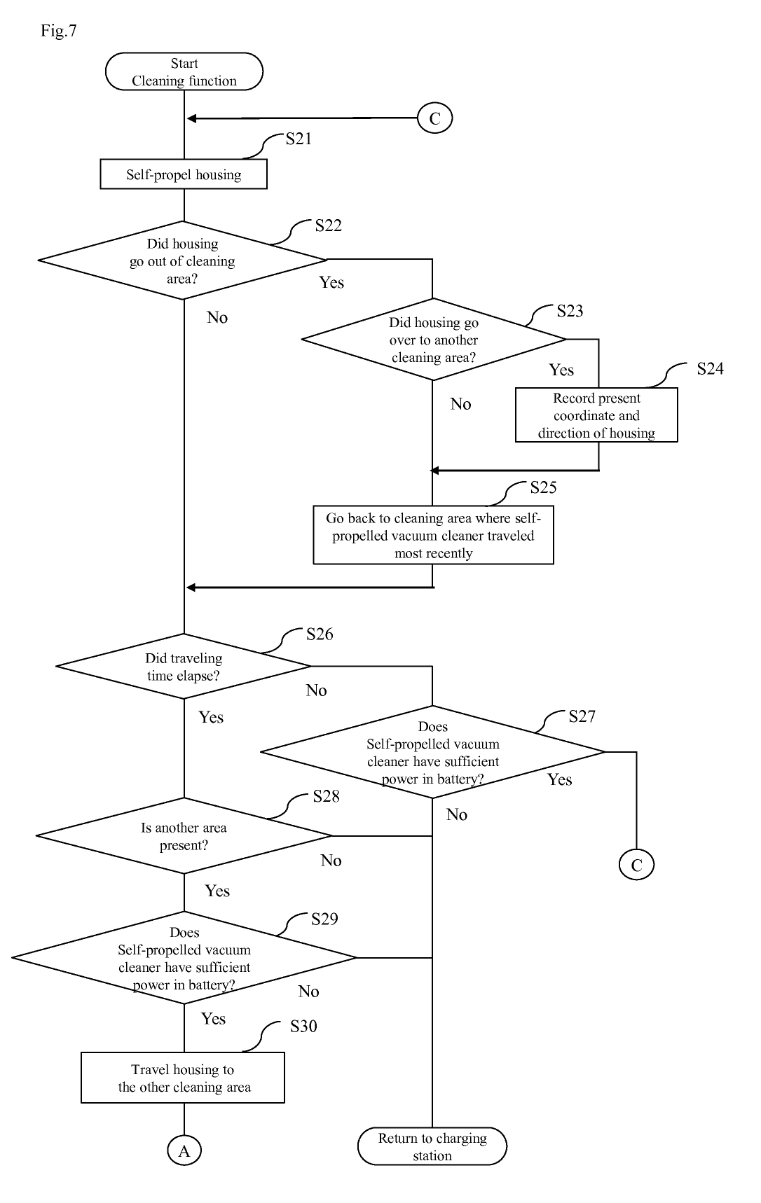

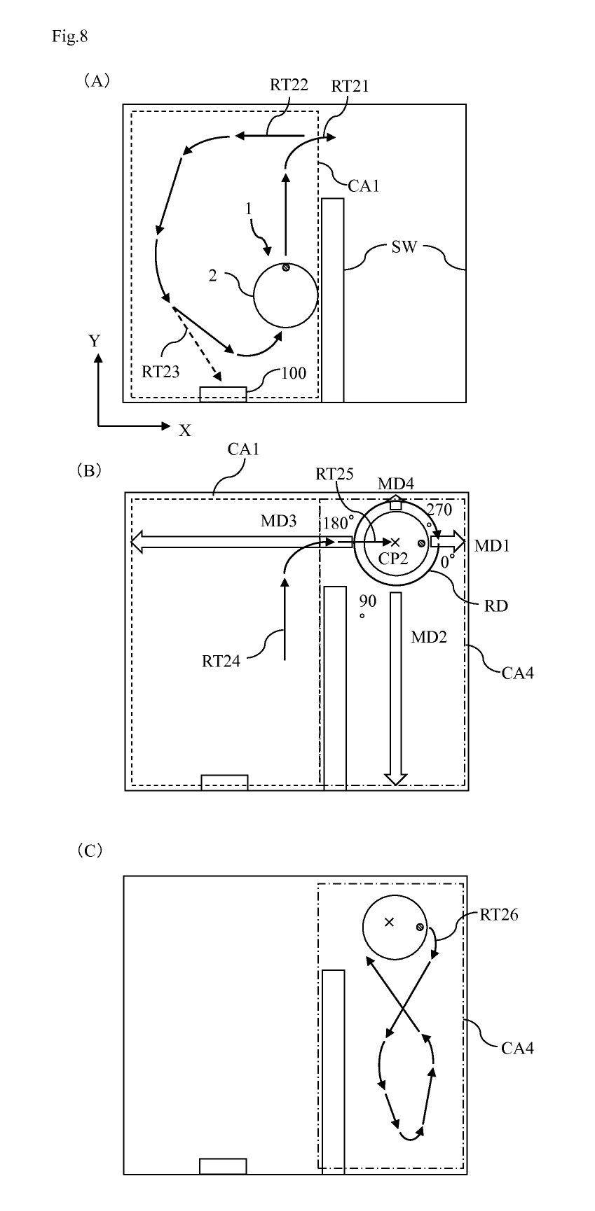

The following explain specific examples of cleaning functioning procedures carried out by the self-propelled vacuum cleaner 1 of Embodiment 3 through the use of FIGS. 7 and 8.

FIG. 7 indicates a flowchart of cleaning functioning processing carried out by the self-propelled vacuum cleaner 1 of this invention.

FIG. 8 illustrates explanatory drawings indicating cleaning functioning procedures carried out by the self-propelled vacuum cleaner 1 of this invention.

In FIGS. 8(B) and (C), reference signs that are used in FIG. 8(A) are omitted.

Embodiment 3 explains a case where the self-propelled vacuum cleaner 1 specifies cleaning areas in order and carries out a cleaning function steadily.

In Embodiment 3, the control unit 11 carries out procedures indicated in the following steps after the self-propelled vacuum cleaner 1 starts the cleaning function.

In step S21 indicated in FIG. 7, the control unit 11 controls the housing 2 to travel randomly (step S21).

In step S22, the control unit 11 determines whether the housing 2 goes out of a cleaning area while being self-propelled (step S22).

In the case where the housing 2 goes out of the cleaning area while being self-propelled (in the case of determining “Yes” in step S21), the control unit 11 moves on to step S23.

In the case where the housing 2 does not go out of the cleaning area while being self-propelled (in the case of determining “No” in step S22), the control unit 11 moves on to step S26.

In step S23, the control unit 11 determines whether the housing 2 goes over to another cleaning area (step S23).

In the case where the housing 2 goes over to the other cleaning area (in the case of determining “Yes” in step S23), the control unit 11 moves on to step S24.

In the case where the housing 2 does not go over to the other cleaning area (in the case of determining “No” in step S23), the control unit 11 moves on to step S25.

Whether the housing goes over to the other cleaning area may be determined by whether a present coordinate of the housing 2 is within ranges of cleaning areas that are already cleaned.

In step S24, the control unit 11 records the present coordinate and a direction of the housing 2 in the memory 51 (step S24).

In step S25, the control unit 11 goes back to the cleaning area where the self-propelled vacuum cleaner traveled most recently (step S25).

Specific examples of how the self-propelled vacuum cleaner goes back to the most recent cleaning area are as follows: The housing 2 rotates 180° on the spot to change its direction and then travels forward; and the housing 2 travels once backwards and then changes its direction to the right or the left to go back to the most recent cleaning area.

Owing to these traveling functions, the housing is capable of going back to the cleaning area again even if the housing 2 goes out of the cleaning area by accident while traveling randomly. In addition, the housing 2 may be prevented from going over to the other cleaning area with reference to a coordinate of the other cleaning area stored in the memory in step S24.

In the case where the self-propelled vacuum cleaner 1 goes out of the cleaning area CA1 (as indicated by a course RT21) as illustrated in FIG. 8(A), the self-propelled vacuum cleaner 1 records a present coordinate and a direction of the housing and then changes its direction to go back to the cleaning area CA1 and to be self-propelled again (as indicated by a course RT22).

In the case where the self-propelled vacuum cleaner 1 becomes low on power in the battery while self-propelling the housing in the cleaning area CA1, the self-propelled vacuum cleaner 1 immediately goes back to the charging station 100 (as indicated by a course RT23).

In step S26, the control unit 11 determines whether a traveling time of the self-propelled vacuum cleaner elapses (step S26).

In the case where the traveling time elapses (in the case of determining “Yes” in step S26), the control unit 11 moves on to step S28.

In the case where the traveling time does not yet elapse (in the case of determining “No” in step S26), the control unit 11 moves on to step S27.

In step S27, the control unit 11 confirms whether the self-propelled vacuum cleaner 1 has sufficient power in the battery with reference to an amount of the power left in the battery (step S27).

In the case where sufficient power is left in the battery (in the case of determining “Yes” in step S27), the control unit 11 goes back to step S21 and controls the self-propelled vacuum cleaner 1 to continue the cleaning function.

In the case where power is not sufficient in the battery (in the case of determining “No” in step S27), the control unit 11 controls the housing 2 to return to the charging station 100.

In step S28, the control unit 11 determines whether another cleaning area is present (step S28).

In the case where the other cleaning area is present (in the case of determining “Yes” in step S28), the control unit 11 moves on to step S29.

In the case where the other cleaning area is not present (in the case of determining “No” in step S28), the control unit 11 controls the housing 2 to return to the charging station 100.

In step S29, the control unit 11 confirms whether the self-propelled vacuum cleaner 1 has sufficient power in the battery with reference to an amount of the power left in the battery (step S29).

In the case where sufficient power is left in the battery (in the case of determining “Yes” in step S29), the control unit 11 moves on to step S30.

In the case where power is not sufficient in the battery (in the case of determining “No” in step S29), the control unit 11 controls the housing 2 to return to the charging station 100.

Lastly, in step S30, the control unit 11 calculates a distance and a direction to another cleaning area with reference to the present position coordinate of the housing 2 and a coordinate of the other cleaning area stored in the memory 51 so as to control the housing 2 to travel to the other cleaning area.

In this case, the control unit 11 controls the housing 2 to travel through a course RT24 along the side wall SW upon coming close to an end of the traveling time in the cleaning area CA1 as illustrated in FIG. 8(B). Because the control unit controls the housing to travel along the side wall, the control unit may find the other cleaning area reliably.

The control unit 11 then goes back to step Si and starts a preparatory function in the other cleaning area.

As illustrated in FIG. 8(B), after the traveling time elapses, and the self-propelled vacuum cleaner finishes cleaning the cleaning area CA1, the self-propelled vacuum cleaner 1 travels to the other cleaning area CA4 (the course RT24)with reference to the recorded position coordinate and direction of the housing.

After entering the other cleaning area CA4, the self-propelled vacuum cleaner 1 travels in the other cleaning area in a similar manner to in Embodiment 1 either to detect any obstacles in front of the housing 2 or to come to a stop after traveling a predetermine distance in the other cleaning area CA4 (i.e., the housing 2 comes to a stop at a reference point CP2 after traveling through a course RT25).

The housing 2 of the self-propelled vacuum cleaner 1 then changes its direction by every 90° and estimates an estimated size of the other cleaning area CA4 so as to determine a traveling time in a similar manner to in Embodiment 1.

The self-propelled vacuum cleaner 1 is then self-propelled randomly in the other cleaning area CA4 as illustrated in FIG. 8(C) (see a course RT26).

As described above, the self-propelled vacuum cleaner is capable of specifying and steadily cleaning the cleaning areas in order.

### Embodiment 4

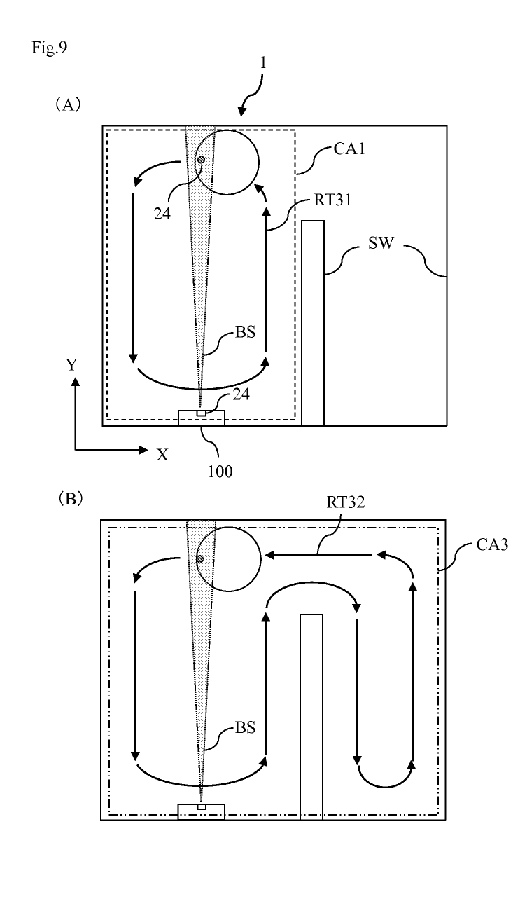

Lastly, specific examples of cleaning functioning procedures carried out by the self-propelled vacuum cleaner 1 of Embodiment 4 will be explained through the use of FIG. 9.

FIG. 9 illustrates explanatory drawings indicating the cleaning functioning procedures carried out by the self-propelled vacuum cleaner 1 of this invention.

In FIG. 9(B), reference signs that are used in FIG. 9(A) are omitted.

In Embodiment 4, the control unit 11 senses how many times the self-propelled vacuum cleaner 1 passes an area of a call-on signal BS transmitted from the call-on signal transmitting unit 102 of the charging station 100 after the self-propelled vacuum cleaner 1 starts cleaning.

As illustrated in FIG. 9(A), the call-on signal BS in the y-axis direction at a specific emission angle(indicated by a shaded part in FIG. 9) is emitted from the charging station 100 placed at the side wall SW.

The self-propelled vacuum cleaner 1 is self-propelled through a random course RT31 inside the cleaning area CA1 and counts the number of the call-on signals BS every time the call-on signal receiving unit 24 passes the area of the call-on signal BS. In the case where the number of the call-on signals reaches the already-determined sensing number (a minimum of the sensing number), the control unit 11 controls the self-propelled vacuum cleaner 1 to return to the charging station 100.

The minimum sensing number is determined by the control unit 11 by referring to, for example, how the estimated size (m²) of the cleaning area relates to the minimum sensing number (times) indicated in the following Table 5.

TABLE 5

| Estimated size (m²) | Minimum sensing number (times) |
|---|---|
| 0-10 | 5 |
| 10-20 | 7 |
| 20-30 | 10 |
| 30-40 | 15 |
| 40-50 | 20 |

Table 5 indicates that, for example, 24 (m²) (the estimated size) of the cleaning area CA1 corresponds to 10 times of the minimum sensing number.

In the case where the self-propelled vacuum cleaner isself-propelled through a random course RT32 inside a cleaning area CA3 as illustrated in FIG. 9(B), and an estimated size of the cleaning area CA3 is found to be approximately 42 (m²), the minimum sensing number is found to be 20 times.

The correlation indicated in Table 5 may be obtained by counting an average of the minimum sensing numbers that the self-propelled vacuum cleaner 1 requires to travel 99% or more of any size of a cleaning area randomly where the charging station 100 is placed in the middle of a side wall and a call-on signal BS passes across the cleaning area.

As described above, the sensing number of the call-on signal BS may be estimated from the estimated size of the cleaning area, with the result that an ending time of the cleaning may be estimated quite easily even if a room layout is complicated.

As described above, the self-propelled vacuum cleaner of this invention is characterized as follows:

(i) A self-propelled vacuum cleaner of this invention comprises a housing; traveling members for allowing the housing to travel; cleaning members for cleaning a floor surface; an obstacle detection unit for detecting positions of obstacles present around the housing; and a control unit for controlling the traveling members, the cleaning members and the obstacle detection unit to allow the housing to clean while the housing is self-propelled, wherein the control unit controls the obstacle detection unit to detect the positions of the obstacles around the housing and determines a traveling time to clean the floor surface on the basis of the positions of the obstacles.

In this invention, the “self-propelled vacuum cleaner” indicates a vacuum cleaner that comprises the housing having an inflow vent disposed at its bottom and a dust collection unit disposed inside the housing; drive wheels for allowing the housing to travel; and the control unit for controlling the drive wheels in such a way as to rotate, stop, change a direction of the housing, etc.; and this invention is exemplified by the above-described Embodiments through the use of the drawings.

The “obstacle detection unit” constitutes the self-propelled vacuum cleaner and is to detect obstacles around the self-propelled vacuum cleaner such as a wall and furniture; and aspects of the obstacle detection unit may be, for example, to equip the housing of the self-propelled vacuum cleaner at its front part with an obstacle sensor such as an ultrasonic sensor or an infrared range instrumentation sensor and to sense distances to the obstacles in different directions from a predetermined distance while changing the direction of the housing by 360° so that the directions and the distances to the obstacles are stored. Further, the self-propelled vacuum cleaner may have several obstacle sensors mounted on the side surface of the housing, the obstacle sensors facing toward different directions, and may measure the distances to the obstacles in the different directions simultaneously. Furthermore, the self-propelled vacuum cleaner may be equipped with the camera and store the directions and the distances to the obstacles obtained from images shot by the camera. Moreover, these functions may be combined.

The obstacles need not necessarily be real objects and may be, for example, electronic obstacles formed by virtual wall signals.

In this invention, “the traveling time during which the housing would be possibly self-propelled” indicates an average time required of the self-propelled vacuum cleaner to travel, for example, 99% or more of the cleaning area randomly. Specific aspects of the traveling time may be, for example, as follows: The self-propelled vacuum cleaner may store in advance data on an average time required of the self-propelled vacuum cleaner to travel a predetermined area so that the control unit may determine with reference to the stored data a traveling time of the self-propelled vacuum cleaner to travel any area randomly. Alternatively, the control unit may determine a traveling time on the basis of a predetermined algorithm.

In the following, preferred embodiments of this invention will be explained.

(ii) The control unit of the self-propelled vacuum cleaner of this invention may determine the traveling area where the housing would be possibly self-propelled on the basis of the positions of the obstacles.

This brings the self-propelled vacuum cleaner into practice to determine the traveling area where the housing would be possibly self-propelled.

In this invention, “the traveling area where the housing would be possibly self-propelled” indicates an area in the form of, for example, a rectangle or an oval where the housing is placed.

The traveling area may also be in the form of a triangle, a square or a polygon, or in another shape. The polygonal area where the housing would be possibly self-propelled may be enclosed by a line that links positions of obstacles around the housing.

(iii) The control unit of the self-propelled vacuum cleaner of this invention may modify the traveling time in the case where the housing goes out of the traveling area while being self-propelled.

This brings the self-propelled vacuum cleaner into practice to modify the already-determined traveling time if the self-propelled vacuum cleaner goes out of the traveling area while being self-propelled.

(iv) In the case where the housing goes out of the traveling area while being self-propelled, the self-propelled vacuum cleaner of this invention may modify the traveling area and the traveling time on the basis of a distance of how far the housing goes out of the traveling area and/or a time of how long the housing goes out of the traveling area.

This brings the self-propelled vacuum cleaner into practice to determine all the traveling areas and the traveling times in order and to travel all the areas reliably even if room layouts are complicated.

(v) In the case where the housing goes out of the traveling area while being self-propelled, the control unit of the self-propelled vacuum cleaner of this invention may control the obstacle detection unit to detect the positions of the obstacles and may modify the traveling time on the basis of the positions of the obstacles.

This brings the self-propelled vacuum cleaner into practice to travel within the traveling time properly on the basis of the positions of the obstacles around the housing.

(vi) The self-propelled vacuum cleaner of this invention may further comprise the call-on signal receiving unit for receiving a call-on signal transmitted from the charging station at a predetermined emission angle, and the control unit may bring an end to the self-propelling of the housing and control the housing to return to the charging station in the case where the call-on signal receiving unit receives the more number of the call-on signals than the predetermined reference number.

This brings the self-propelled vacuum cleaner into practice to end the self-propelling of the housing with proper timing even if the self-propelled vacuum cleaner does not accurately figure out the shape and/or the size of the entire traveling area because of its complicated layout. The self-propelled vacuum cleaner, therefore, is capable of reducing costs since the self-propelled vacuum cleaner requires neither equipment such as a gyro sensor or a camera nor complicated functions such as a mapping function that may be used to figure out the shape and/or the size of the traveling area.

The above-described preferred Embodiments of this invention may be combined in various ways.

This invention may have a variety of modified examples besides the above-described Embodiments. These modified examples should be comprehended to fall within the range of this invention. This invention should include the scope of claims and all varied examples comparable to those in claims and within the claims.

### REFERENCE SIGNS LIST

1: self-propelled vacuum cleaner
2: housing
2b: top board
2c: side plate
3: cover
10: side broom
11: control unit
12: traveling control unit
13: drive wheel
14: obstacle detection unit
15: rechargeable battery
17: operation input unit
18: voice input unit
19: voice recognition unit
20: voice output unit
22: image capture unit
23: lighting unit
24: call-on signal receiving unit
25: charging connection
27: counter
28: communication unit
31: dust collection unit
32: ion-generating device
33: fan control unit
34: exhaust vent
35: inflow vent
36: electric fan
51: memory
52: traveling characteristic information
53: voice registration information
54: input voice data
56: captured image data
100: charging station
101: charging terminal unit
102: call-on signal transmitting unit
CN: counting number
FD: forward direction
SW: side wall

What is claimed is:

1. A self-propelled vacuum cleaner comprising a housing; traveling members for allowing the housing to travel; cleaning members for cleaning a floor surface; an obstacle detection unit for detecting positions of obstacles present around the housing; and a control unit for controlling the traveling members, the cleaning members and the obstacle detection unit to allow the housing to clean the floor surface while the housing is self-propelled,
wherein the control unit controls the obstacle detection unit to detect the positions of the obstacles around the housing and determines a traveling time to clean the floor surface on the basis of the positions of the obstacles.

2. The self-propelled vacuum cleaner according to claim 1, wherein the control unit determines the traveling area where the housing would be possibly self-propelled on the basis of the positions of the obstacles.

3. The self-propelled vacuum cleaner according to claim 2, wherein the control unit modifies the traveling time in the case where the housing goes out of the traveling area while being self-propelled.

4. The self-propelled vacuum cleaner according to claim 3, wherein the control unit modifies the traveling area and the traveling time on the basis of a distance of how far the housing goes out of the traveling area and/or a time of how long the housing goes out of the traveling area.

5. The self-propelled vacuum cleaner according to claim 3, wherein the control unit controls the obstacle detection unit to detect the positions of the obstacles and modifies the traveling time on the basis of the positions of the obstacles.
